(19) United States
(12) Patent Application Publication
(10) Pub. No.: US 2007/0115214 A1
(43) Pub. Date: May 24, 2007

(54) Plasma display and driving method thereof

(76) Inventors: Kwang-Sig Jung, Yongin-si (KR); Su-Yong Chae, Yongin-si (KR); Dae-Hwan Kim, Yongin-si (KR)

Correspondence Address: LEE & MORSE, P.C., 3141 FAIRVIEW PARK DRIVE, SUITE 500, FALLS CHURCH, VA, 22042, US

(21) Appl. No.: 11/602,197

(22) Filed: Nov. 21, 2006

(30) Foreign Application Priority Data
Nov. 22, 2005 (KR) 10-2005-0111686

(51) Int. Cl. G09G 3/28

(52) U.S. Cl. 345/63

(57) ABSTRACT

In a plasma display device, subfields may be divided into subfield groups and row electrodes are driven by row groups. Non-light emitting cells may be selected from discharge cells of the row groups during a first address period of the row groups, and light emitting cells of the row groups may be sustain discharged during a first sustain period between two adjacent first address periods in the respective subfields of the first subfield group. A weight of at least one first subfield of the first subfield group may be different from that of at least one second subfield of the first subfield group.

### BACKGROUND OF THE INVENTION

1. Field of the Invention

The present invention relates to a plasma display device and a driving method thereof.

2. Description of the Related Art

A plasma display device is a plasma display panel (PDP) based display device for displaying characters or images by using plasma generated by a gas discharge. The PDP may have a plurality of discharge cells in a matrix format.

In the plasma display device, a field (1 TV field) may be divided into a plurality of subfields, each of which has a weight value, and grayscales may be displayed by a combination of weight values of subfields at which a display operation is generated. Each subfield may have a reset period, an address period, and a sustain period. The reset period resets discharge cells so as to perform a next address discharge in a stable manner. The address period selects discharge cells that will emit light and discharge cells that will not emit light from among a plurality of discharge cells. The sustain period sustains the discharge cell selected in the address period so as to actually display the image.

An address display period separation (ADS) method applies an address operation to all the discharge cells in each subfield and sustains all the discharge cells to thus temporally divide the address period and the sustain period. The ADS method is easily realized, but since all the discharge cells are sequentially addressed, the discharge cells that will be addressed later temporally may be not addressed well due to insufficient priming particles in the discharge cells. Therefore, the width of scan pulses sequentially applied to the scan electrodes needs to be increased to realize stable address discharges, thereby increasing the length of the address period. As a result, the length of the subfields is increased, and the number of subfields that may be realized in a single field is accordingly limited.

An address while display (AWD) method does not divide the address period and the sustain period. Differing from the ADS method, the AWD method inserts an address pulse of each line between consecutive sustain pulses, and performs an address operation on one line while performing a sustain discharge operation on another line. The AWD method controls the address pulse and the sustain pulse to be consecutively progressed, and requires a reset pulse between the consecutive pulses. Therefore, a long reset pulse cannot be used. Since the reset discharge thus needs to be performed by a strong discharge, the black screen looks bright and the contrast ratio becomes bad.

Both the ADS method and the AWD method use subfields having different weights to express grayscales. However, contour noise may be generated when only a few subfields are used. For example, when using subfields having weights that are increasing powers of two, contour noise is generated when a single discharge cell expresses the grayscale of 127 and 128 in two consecutive frames.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention is therefore directed to a plasma display and driving method thereof, which substantially overcomes one or more of the problems due to the limitations and disadvantages of the related art.

It is therefore a feature of an embodiment of the present invention to provide to provide a plasma display device and a driving method thereof that realizes high-speed scanning.

It is therefore another feature of an embodiment of the present invention to provide to provide a plasma display device and a driving method thereof that improves contrast ratio.

It is therefore yet another feature of an embodiment of the present invention to provide to provide a plasma display device and a driving method thereof that reduces contour noise

It is therefore a feature of an embodiment of the present invention to provide to provide a plasma display device and a driving method thereof that increases the number of grayscales.

It is therefore a feature of an embodiment of the present invention to provide to provide a plasma display device and a driving method thereof reducing the number of subfields.

At least one of the above and other features and advantages of the present invention may be realized by providing a plasma display device driving method for dividing a field into a plurality of subfields and expressing grayscales in a plasma display device including a plurality of row electrodes, a plurality of column electrodes, and a plurality of discharge cells defined by the row electrodes and the column electrodes, the method including dividing the row electrodes into a plurality of row groups, dividing the subfields into a plurality of subfield groups, selecting non-light emitting cells from among light emitting cells of the respective row groups during first address periods of the row groups in the respective subfields of a first subfield group, and sustain discharging remaining light cells among the light emitting cells of the row groups during a first sustain period provided between two adjacent first address periods in the respective subfields of the first subfield group, wherein a weight of at least one first subfield of the first subfield group is different from a weight of at least one second subfield of the first subfield group.

At least one of the above and other features and advantages of the present invention may be realized by providing a plasma display device driving method for dividing a field into a plurality of subfields and expressing grayscales in a plasma display device including a plurality of row electrodes, a plurality of column electrodes, and a plurality of discharge cells defined by the row electrodes and the column electrodes, the method including dividing the subfields into a plurality of subfield groups including a first subfield group and a second subfield group, selecting light emitting cells from among the discharge cells, sustain discharging the light emitting cells in the first subfield group including a plurality of subfields having weights, dividing the row electrodes into a plurality of row groups in the second subfield group, selecting light emitting cells from among the discharge cells of a first row group from among the row groups, sustain discharging the light emitting cells of the row groups in at least one first subfield that begins the second subfield group, dividing a plurality of second subfields of the second subfield group into a plurality of subfield sub-groups having weights, selecting non-light emitting cells from the light emitting cells of the first row group, and sustain discharging remaining light emitting cells among the light emitting cells of the row groups in the second subfields of the subfield sub-groups.

At least one of the above and other features and advantages of the present invention may be realized by providing a plasma display device including a plasma display panel (PDP) including a plurality of row electrodes having first electrodes and second electrodes and a plurality of column electrodes formed to cross the row electrodes, wherein a plurality of discharge cells are formed by the row electrodes and the column electrodes, a controller for dividing the row electrodes into a plurality of row groups, dividing the subfields into a plurality of subfield groups, and expressing grayscales, and a driver for selecting non-light emitting cells from among light emitting cells of the row groups during first address periods of the row groups and sustain discharging remaining light emitting cells among the light emitting cells of the row groups during a first sustain period provided between two adjacent first address periods in respective subfields of the first subfield group, wherein the controller controls a length of a first sustain period of at least one first subfield from among subfields of the first subfield group to be different from a length of a first sustain period of at least one second subfield from among subfields of the first subfield group.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a plasma display device for use with embodiments of the present invention;

FIG. 2 illustrates a plasma display device driving method according to a first embodiment of the present invention;

FIG. 3 illustrates a detailed plasma display device driving waveform for the method shown in FIG. 2;

FIG. 4 illustrates a grayscale expressing method according to the first embodiment according to the driving method shown in FIG. 2;

FIG. 5 illustrates a plasma display device driving method according to a second embodiment of the present invention;

FIG. 6 and FIG. 7 respectively illustrate a grayscale expressing method according to second and third embodiments according to the driving method shown in FIG. 5.

### DETAILED DESCRIPTION OF THE INVENTION

Korean Patent Application No. 10-2005-0111686 filed on Nov. 22, 2005, in the Korean Intellectual Property Office, and entitled: “Plasma Display and Driving Method Thereof” is incorporated by reference herein in its entirety.

In the following detailed description, only certain exemplary embodiments of the present invention have been shown and described, simply by way of illustration. As those skilled in the art would realize, the described embodiments may be modified in various different ways, all without departing from the spirit or scope of the present invention. To clarify the embodiment of the present invention, parts that are not described are omitted, and same parts have the same reference numerals throughout the specification. Also, when a part is described to include predetermined constituent elements, it means that the part may further include other constituent elements in addition to the constituent elements.

Wall charges in the embodiments of the present invention represent charges formed and accumulated on a wall (e.g., a dielectric layer) close to an electrode of a discharge cell. Although the wall charges do not actually touch the electrodes, the wall charges will be described as being “formed” or “accumulated” on the electrode. Further, a wall voltage represents a potential difference formed on the wall of the discharge cell by the wall charges.

A plasma display device that may be used with embodiments of the present invention will now be described in detail. Details of the driving scheme providing features over current driving schemes will be discussed in detail following the description of the plasma display device. The following plasma display device configuration represents an example, and other types of panels to which the driving waveform to be described is applicable may use embodiments of the present invention.

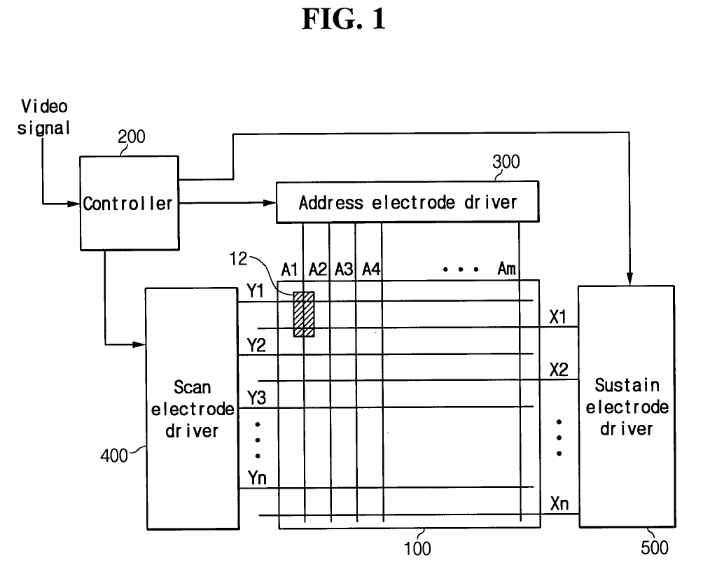

As shown in FIG. 1, a plasma display device may include a plasma display panel (PDP) 100, a controller 200, an address electrode driver 300, a scan electrode driver 400, and a sustain electrode driver 500.

The PDP 100 may include a plurality of address electrodes (A electrodes) A1-Am in a column direction, and pluralities of sustain electrodes (X electrodes) X1-Xn and scan electrodes (Y electrodes) Y1-Yn in pairs in a row direction. The X electrodes X1-Xn may be formed to correspond to the respective Y electrodes Y1-Yn, and the X electrodes and the Y electrodes perform a display operation for displaying images during the sustain period. The Y electrodes Y1-Yn and the X electrodes X1-Xn may cross the A electrodes A1-Am.

Discharge spaces may exist where the A electrodes A1-Am, and the X and Y electrodes X1-Xn and Y1-Yn meet to form cells 12. The X electrodes and the Y electrodes provided in pairs in the row direction will be referred to as row electrodes, and the A electrodes provided in the column direction will be referred to as column electrodes.

The controller 200 may receive video signals and may output an A electrode driving control signal, an X electrode driving control signal, and a Y electrode driving control signal. The controller 200 may divide a frame into a plurality of subfields, each of which has a luminance weight, and may drive the subfields that are also driven by division of a plurality of groups. Further, the X electrodes and the Y electrodes may be respectively driven by division of a plurality of groups.

The address electrode driver 300 may receive an A electrode driving control signal from the controller 200, and may apply a driving voltage to the A electrodes A1-Am. The scan electrode driver 400 may receives a Y electrode driving control signal from the controller 200, and may apply a driving voltage to the Y electrodes Y1-Yn. The sustain electrode driver 500 may receive an X electrode driving control signal from the controller 200, and may apply a driving voltage to the X electrodes X1-Xn.

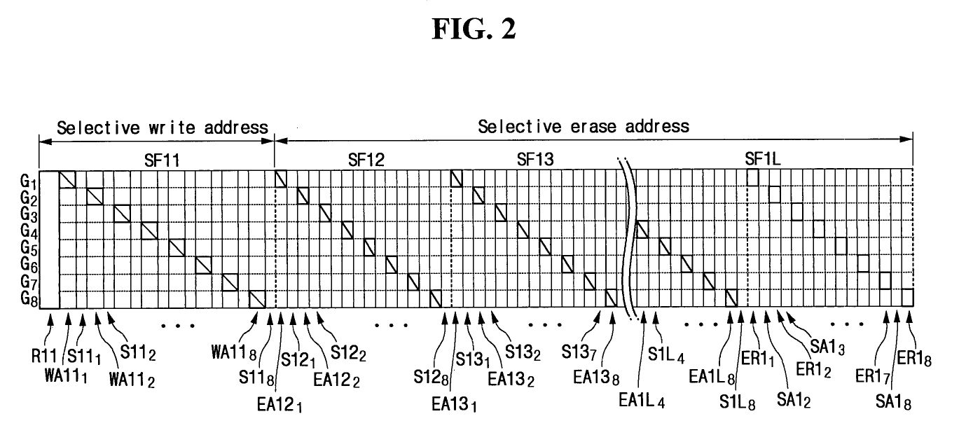

Referring to FIG. 2, a plasma display device driving method according to the first embodiment of the present invention will be described. In the first embodiment of the present invention, lengths of sustain periods applied after the address period in the row group may be the same, and the sustain periods may have the same length in the subfields.

FIG. 2 illustrates a plasma display device driving method according to the first embodiment of the present invention.

As shown in FIG. 2, a field may have a plurality of subfields SF11-SF1L, and the row electrodes X1-Xn and Y1-Yn may be divided into a plurality of row groups. It is assumed in FIG. 2 that the row electrodes X1-Xn and Y1-Yn are arranged according to a predetermined order to be divided into eight groups. In this instance, the 1^{st} to j-th row electrodes may be the first row group G₁, and the (j+1)-th to 2j-th row electrodes may be the second row group G₂. In a like manner, the (7j+1)-th to n-th row electrodes may be the eighth row group G₈ (where j=n/8). Alternatively, row electrodes at other regular intervals may form groups, row electrodes may be a single group or row electrodes at irregular intervals may be predetermined groups.

The first subfield SF11 may have a reset period R11, address periods WA11₁-WA11₈, and sustain periods S11₁-S11₈. The address periods WA11₁-WA11₈ of the first subfield SF11 may be controlled by the selective write address method. The subfields from the second subfield to the last subfield SF12-SF1L may have address periods EA12₁-EA1L₈ and sustain periods S12₁-S1L₈. The address periods EA12₁-EA1L₈ from the second subfield to the last subfield SF12-SF1L may be controlled by the selective erase address method. Hence, in the first embodiment of the present invention, the subfields SF11-SF1L may include a selective write address type subfield group and a selective erase address type subfield group.

The selective write address method and the selective erase address method may be used to select discharge cells that will emit light and discharge cells that will not emit light from among a plurality of discharge cells. The selective write address method may select the discharge cells that will emit light to generate a predetermined wall voltage, and the selective erase address method may select the discharge cells that will not emit light to eliminate the generated wall voltage. That is, the selective write address method addresses the cells that do not emit light to generate wall charges and establishes the cells to be cells that will emit light, while the selective erase address method addresses the cells that emit light to eliminate the generated wall charges and establishes the cells to be cells that do not emit light. In the subfields that have a selective write address type address period, a reset period for resetting the cells that emit light to be cells that do not emit light is provided. The address discharge for forming wall charges in the selective write address method will be referred to as a write discharge, and the address discharge for eliminating the wall charges in the selective erase address method will be referred to as an erase discharge.

Referring to FIG. 2, the first subfield SF11 having a selective write address type address period may have a reset period R11 for resetting the discharge cells to be cells that do not emit light. That is, the reset period R11 of the first subfield SF11 may reset the discharge cells of the row groups G₁-G₈ to be cells that do not emit light, and the address period WA11₁-WA11₈ may set the discharge cells to be cells that allow a write discharge.

In the first subfield SF11, the address periods WA11₁-WA11₈ and the sustain periods S11₁-S11₈ of the first to eighth row groups G₁-G₈ may be sequentially performed. That is, the sustain period S11ᵢ of the i-th row group Gᵢ may be performed after the address period WA11ᵢ of the i-th row group Gᵢ is performed. Next, the address period WA11ᵢ₊₁ and the sustain period S11ᵢ₊₁ of the (i+1)-th row group Gᵢ₊₁ may be performed.

In detail, discharge cells that will be set as light emitting cells may be write discharged from among discharge cells of the first row group G₁ to generate wall charges in the address period WA11₁, and the light emitting cells of the first row group G₁ may be sustain discharged in the sustain period S11₁. Discharge cells that will be set as light emitting cells may be write discharged from among discharge cells of the second row group G₂ to generate wall charges in the address period WA11₂, and the light emitting cells of the second row group G₂ may be sustain discharged in the sustain period S11₂. In this instance, the light emitting cells of the first row group G₁ are sustain discharged. In a like manner, the above-noted operation is performed for the other row groups G₃-G₈ in the address periods WA11₃-WA11₈ and the sustain periods S11₃-S11₈.

In this instance, the light emitting cells of the i-th row group Gᵢ and the light emitting cells of the first to (i−1)-th row groups G₁-Gᵢ₋₁ may be sustain discharged in the sustain period S11ᵢ of the i-th row group Gᵢ. The discharge cells of the i-th row group Gᵢ that are set to be the light emitting cells in the first subfield SF11 are sustain discharged up to the sustain periods S11ᵢ-S11₈ and S12₁-S12ᵢ₋₁ that are provided in advance to the address period EA12ᵢ of the i-th row group Gᵢ of the second subfield SF12. That is, the light emitting cells of the i-th row group Gᵢ may be sustain discharged during the eight sustain periods.

Next, predetermined operations may be sequentially performed during the address periods EA12₁-EA12₈ and the sustain periods S12₁-S12₈ of the first to eighth row groups G₁-G₈ in the second subfield SF12 having a selective erase address type address period. That is, an operation of the sustain period S12ᵢ of the i-th row group Gᵢ may be performed after an operation of the address period EA12ᵢ of the i-th group Gᵢ is performed. Next, predetermined operations provided for the address period EA12ᵢ₊₁ and the sustain period S12ᵢ₊₁ of the (i+1)-th group Gᵢ₊₁ may be performed.

In detail, wall charges may be erased by erase discharging the discharge cells that will be set to be non-light emitting cells from among the light emitting cells of the first row group G₁ in the address period EA12₁, and other light emitting cells of the first row group G₁ may be sustain discharged in the sustain period S12₁. Next, wall charges may be erased by erase discharging the discharge cells that will be set to be non-light emitting cells from among the light emitting cells of the second row group G₂ in the address period EA12₂, and other light emitting cells of the second row group G₂ may be sustain discharged in the sustain period S12₂. In this instance, the light emitting cells of the first row group G₁ may be sustain discharged. In a like manner, the above-noted operation is performed for the other row groups G₃-G₈ in the address periods EA12₃-EA12₈ and the sustain periods S12₃-S12₈.

In a like manner, the light emitting cells of the i-th row group Gᵢ and the light emitting cells of the first to (i−1)-th row groups G₁-Gᵢ₋₁ may be sustain discharged in the sustain period S12ᵢ of the i-th row group Gᵢ. The discharge cells of the i-th row group Gᵢ may be sustain discharged up to the sustain periods S11ᵢ-S11₈ and S12₁-S12ᵢ₋₁ that are provided in advance to the address period EA13ᵢ of the i-th row group Gᵢ of the third subfield SF13. That is, the light emitting cells of the i-th row group Gᵢ may be sustain discharged during the eight sustain periods.

As to the other subfields SF13-SF1L having the selective erase address type address period, in a like manner of the second subfield SF12, predetermined operations may be performed for the respective row groups G₁-G₈ in the address periods EA13₁-EA13₈, . . . , EA1L₁-EA1L₈ and the sustain periods S13₁-S13₈, . . . , S1L₁-S1L₈. As a result, predetermined discharge cells that are set to be light emitting cells by a write discharge in the first subfield SF11 may be consecutively sustain discharged until they are set to be non-light emitting cells by an erase discharge in the address period EA12ᵢ-EA1Lᵢ of the subsequent subfields SF12-SF1L, and they are not sustain discharged starting from the corresponding subfield when they are set to be the non-light emitting cells by the erase discharge.

When the sustain period S1L₈ of the last subfield SF1L is finished, eight sustain discharges may be generated in the first row group G₁, seven sustain discharges may be generated in the second row group G₂, and six sustain discharges may be generated in the third row group G₃. Also, five sustain discharges may be generated in the fourth row group G₄, and four sustain discharges may be generated in the fifth row group G₅. Three sustain discharges may be generated in the sixth row group G₆, two sustain discharges may be generated in the seventh row group G₇, and one sustain discharge may be generated in the eighth row group G₈.

Therefore, the last subfield SF1L may have erase periods ER1₁-ER1₇ and additional sustain periods SA1₂-SA1₈ so that the number of sustain discharges generated in the first to eighth row groups G₁-G₈ may be the same.

In detail, no additional sustain discharge is needed for the first row group G₁, i.e., eight sustain discharges may be generated before the erase period ER1₁. Hence, the wall charges formed on the light emitting cells of the first row group G₁ may be erased in the erase period ER1₁. The light emitting cells of the first to eighth row groups G₁-G₈ are controlled to emit light in the additional sustain period SA1₂. In this instance, since the wall charges formed on the light emitting cells of the first row group G₁ are erased in the erase period ER1₁, one additional sustain discharge may be generated in the light emitting cells of the second to eighth row groups G₂-G₈ in the additional sustain period SA1₂.

Since the second row group G₂, in which eight sustain discharges may be generated by the sustain period SA1₂, requires no further additional sustain discharge, the wall charges formed on the light emitting cells of the second row group G₂ may be erased in the erase period ER1₂. In this instance, since the wall charges formed on the light emitting cells of the first and second row groups G₁ and G₂ may be erased in the erase periods ER1₁ and ER1₂, respectively, one additional sustain discharge may be generated on the light emitting cells of the third to eighth row groups G₃-G₈ in the additional sustain period SA1₃.

Since the third row group G₃, in which eight sustain discharges are generated by the additional sustain period SA1₂, requires no further additional sustain discharge, the wall charges formed on the light emitting cells of the third row group G₃ may be erased in the erase period ER1₃. In this instance, since the wall charges formed on the light emitting cells of the first to third row groups G₁-G₃ may be erased in the erase periods ER1₁-ER1₃, one additional sustain discharge may be generated on the light emitting cells of the fourth to eighth row groups G₄-G₈ in the additional sustain period SA1₄.

In a like manner, when predetermined operations are performed in the erase periods ER1₄-ER1₈ and the additional sustain periods SA1₄-SA1₈, the numbers of sustain discharges of the first to eighth row groups G₁-G₈ may be the same.

An erase period ER1₈ for erasing the wall charges of the eighth row group G₈ can be formed after the additional sustain period SA1₈. Also, since an operation is performed on the first subfield SF11 of a subsequent field in the reset period R11, the erase period ER1₈ of the eighth row group G₈ may not be formed. The erase operation in the erase periods ER1₁-ER1₈ may be sequentially performed on the respective row electrodes of the respective groups in a like manner of the address period, and may be simultaneously performed on the row electrodes of the respective row groups.

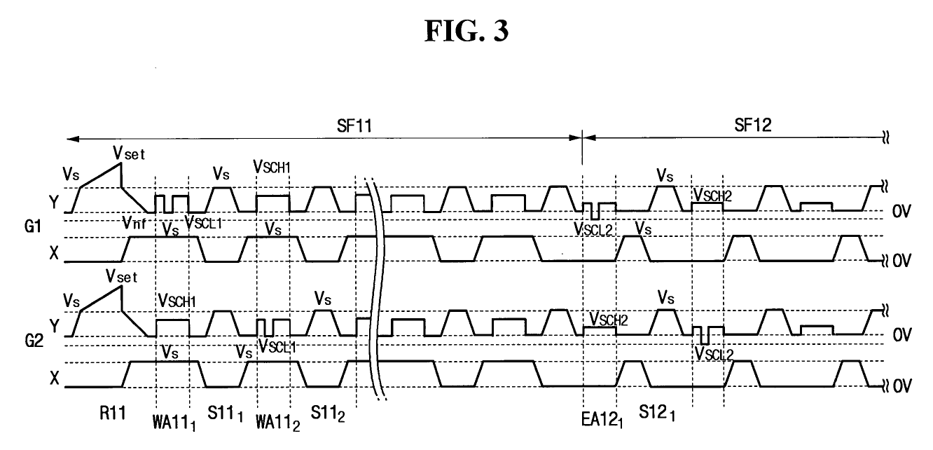

Driving waveforms for the plasma display device driving method according to the first embodiment of the present invention will now be described in detail with reference to FIG. 3.

FIG. 3 illustrates a detailed plasma display device driving waveform diagram for the driving method shown in FIG. 2. FIG. 3 illustrates the first and second row groups G₁ and G₂, the first and second subfields SF11 and SF12, and no driving waveform applied to the electrode A, for better understanding and ease of description.

As shown in FIG. 3, the voltage at the Y electrode of the row groups G₁-G₈ may be gradually increased from the voltage of Vs to the voltage of Vset while a reference voltage (e.g., 0V in FIG. 3) may be applied to the X electrode in the reset period R11 of the first subfield SF11. As a result, a weak reset discharge may be generated between the Y electrode and the X electrode, and wall charges may be formed on the discharge cells of the row groups G₁-G₈ while the voltage at the Y electrode is increased. While the voltage of Vs is applied to the X electrode, the voltage at the Y electrodes of the row groups G₁-G₈ may be gradually decreased from the voltage of Vs to the voltage of Vnf. While the voltage at the Y electrode is decreased, a weak reset discharge may be generated between the Y electrode and the X electrode to erase the wall charges formed on the discharge cells of the row groups G₁-G₈ and to reset the discharge cells to be non-light emitting cells. In general, the voltage of Vnf-Vs may be set to be near the discharge firing voltage between the Y electrode and the X electrode. The wall voltage between the Y electrode and the X electrode may almost reach 0V to prevent the non-light emitting cells, in which no write discharge is generated in the address period, from being misfired in the sustain period.

In the address period WA11₁, a scan pulse with the voltage of VscL1 may be sequentially applied to the Y electrodes of the first row group G1 while the voltage of Vs is applied to the X electrode. In this instance, an address pulse (not shown) with a positive voltage may be applied to the A electrode of the discharge cell to emit light from among the discharge cells that are formed by the Y electrode to which the scan pulse is applied. The discharge cells to which the voltage of VscL1 of the scan pulse and the positive voltage of the address pulse are applied may be write discharged to form a wall voltage at the X electrode and the Y electrode, and to be switched to the light emitting cells.

The voltage of VscH1 that is greater than that of the scan pulse may be applied to the Y electrode to which no scan pulse is applied, and a reference voltage may be applied to the A electrode to which no address pulse is applied (not shown.) During the address period WA11₁, the voltage of VscH1 may be applied to the Y electrodes of the second to eighth row groups G₂-G₈.

Next, a sustain pulse with the voltage of Vs may be applied to the Y electrodes of the row groups G₁-G₈ in the sustain period S11₁ to sustain discharge the light emitting cells. The sustain pulse with the voltage of Vs may be applied to the X electrodes of the row groups G₁-G₈ to sustain discharge the light emitting cells. In this instance, the cells in which the write discharge is generated in the address period WA11₁ of the first row group G₁ are switched to the light emitting cells, and hence, the same cells are sustain discharged.

While the sustain pulse is applied to the X electrode, the scan pulse with the voltage of VscL1 may be sequentially applied to the Y electrodes of the second row group G₂ while the voltage of Vs may be applied to the X electrode in the address period WA11₂, and an address pulse with a positive voltage may be applied to the A electrode of the discharge cell to emit light from among discharge cells formed by the Y electrode to which the scan pulse is applied, so that the non-light emitting cells are write discharged to set them to be light emitting cells.

Next, a sustain pulse with the voltage of Vs may be applied to the Y electrodes of the row groups G₁-G₈ in the sustain period S11₂ to sustain discharge the light emitting cells. A sustain pulse with the voltage of Vs may be applied to the X electrodes of the row groups G₁-G₈ to sustain discharge the light emitting cells. In this instance, the cells that are write discharged in the address period WA11₁ and WA11₂ of the first and second row groups G₁ and G₂ are the light emitting cells that are sustain discharged. In a like manner, corresponding operations are performed in the address period and sustain period for the respective row groups in the first subfield SF11.

Next, a scan pulse with the voltage of VscL2 may be sequentially applied to the Y electrodes of the first row group G₁ in the address period EA12₁ of the second subfield SF12, while the reference voltage may be applied to the X electrode. In this instance, an address pulse (not shown) with a positive voltage may be applied to the A electrode of a cell that will be selected as a non-light emitting cell from among the light emitting cells (in which a sustain discharge is generated in the first subfield) that are formed by the Y electrode to which the scan pulse is applied. The voltage of VscH2 that is greater than VscL2 may be applied to the Y electrode to which no scan pulse is applied. An erase discharge may be generated at the light emitting cells to which the voltage of VscL2 of the scan pulse and the positive voltage of the address pulse are applied, so that the wall charges formed at the X electrode and the Y electrode may be erased and the cells may be set to be non-light emitting cells.

Since the cells in which no erase discharge is generated in the address period EA12₁ of the second subfield SF12 are the light emitting cells of the second subfield SF12 from among the light emitting cells of the first subfield SF11, a sustain pulse with the voltage of Vs may be applied to the X electrodes of the row groups G₁-G₈ in the sustain period S12₁ of the second subfield SF12 to sustain discharge the light emitting cells, and the voltage of Vs may be applied to the Y electrodes of the row groups G₁-G₈ to sustain discharge the light emitting cells.

In the address period EA12₂, while the reference voltage is applied to the X electrode, a scan pulse with the voltage of VscL2 that is a negative voltage may be sequentially applied to the Y electrodes of the second row group G₂, and an address pulse (not shown) with a positive voltage may be applied to the A electrode of a cell to be selected as a non-light emitting cell from among light emitting cells (the cells that are sustain discharged in the first subfield) formed by the Y electrode to which a scan pulse is applied. An erase discharge may be generated at the light emitting cell to which the voltage of VscL2 of the scan pulse and the positive voltage of the address pulse are applied, so that the wall charges formed on the X electrode and the Y electrode may be erased and the cell may be set to be a non-light emitting cell.

In the sustain period S12₂, a sustain pulse with the voltage of Vs may be applied to the X electrodes of the row groups G₁-G₈ to sustain discharge the light emitting cell, and the voltage of Vs may be applied to the Y electrodes of the row groups G₁-G₈ to sustain discharge the light emitting cell. In a like manner, corresponding operations for the other row groups G₃-G₄ may be performed in the address period and the sustain period.

Accordingly, in the first embodiment of the present invention, the address period may be provided between the sustain periods of the row groups, and the priming particles that are generated in the sustain period may be sufficiently used in the address period, and hence, high-speed scanning is possible by reducing the width of the scan pulse. No strong discharge is generated in the reset period, since a gradually increasing voltage and a gradually decreasing voltage may be used in the reset period. The contrast ratio may be increased, since a single reset period may be performed during a single field for the row groups.

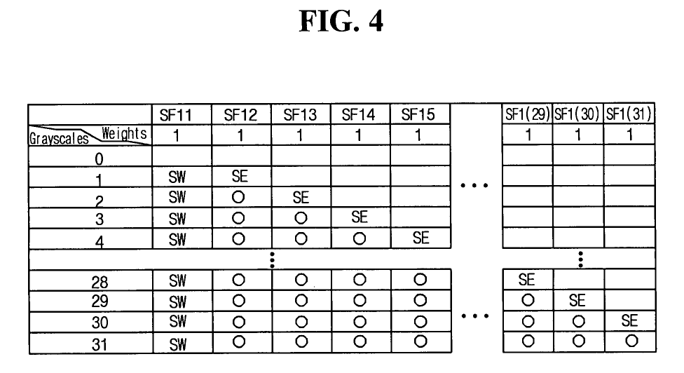

Referring to FIG. 4, a grayscale expressing method with the driving method of FIG. 2 will now be described.

FIG. 4 illustrates a grayscale expressing method according to the driving method of FIG. 2. As shown in FIG. 4, a single field may have 31 subfields. In FIG. 4, “SW” indicates that a write discharge is generated in the corresponding subfield to set the non-light emitting cell to be a light emitting cell, and “SE” indicates that an erase discharge is generated in the corresponding subfield to set the light emitting cell to be a non-light emitting cell. Also, “∘” indicates a subfield in the light emitting cell state. The grayscale for the case in which a sustain discharge is generated in a single subfield may be set to 1.

As shown in FIG. 4, when the cell becomes a light emitting cell in the address period WA11ᵢ of the first subfield SF11, no sustain discharge is generated in the sustain period S11ᵢ, a sustain discharge is also not generated in the next subfields SF12-SF1L, and the grayscale of 0 is expressed. When the cell becomes a light emitting cell in the address period WA11ᵢ of the first subfield SF11, a sustain discharge is generated in the first subfield SF11, and the grayscale of 1 is expressed. Next, when an erase discharge is generated in the second subfield SF12 to switch the cell into a non-light emitting cell, no sustain discharge is generated from the second subfield SF12, and the grayscale of 1 is maintained. Also, when no erase discharge is generated in the second subfield SF12, the cell is still a light emitting cell, a sustain discharge is generated in the second subfield SF12, and the grayscale of 1 is expressed. That is, when the cell becomes a light emitting cell in the first subfield SF11, the discharge cell that becomes the non-light emitting cell in the K-th subfield SF1K is sustain discharged from the first subfield SF11 to the (K−1)-th subfield SF1(K−1), and the grayscale of (K−1) is finally expressed. That is, when a single field has 31 subfields as shown in FIG. 4, 32 grayscales from 0 to 31 can be expressed.

Accordingly, no contour noise is generated, since the grayscales are expressed by the subfields that are consecutively turned on from the first subfield in the first exemplary embodiment. However, since the number of subfields provided to one field is limited, the number of grayscales expressed by the subfields is limited.

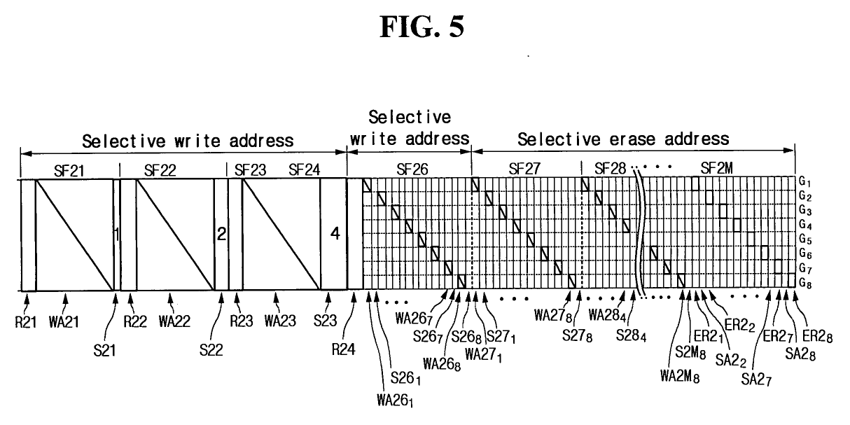

Referring to FIG. 5, a method for increasing the number of grayscales to be expressed by combination of subfields in a field will now be described.

FIG. 5 illustrates a plasma display device driving method according to a second embodiment of the present invention.

As shown in FIG. 5, the driving method may divide a plurality of subfields SF21-SF2M to two groups of subfields. The first group of subfields includes first to third subfields SF21-SF23. In this instance, the subfields SF21-SF23 of the first group may be provided before the subfields SF24-SF2M of the second group, each of which has a weight. The address periods WA21-WA23 of the subfields of the first group may be based on the selective write address method. In the subfields SF21-SF23 of the first group, the row electrodes may not grouped, and a light emitting cell may be selected from among discharge cells formed by the row electrodes during an address period. The subfields SF24-SF2M of the second group may correspond to the subfields SF11-SF1L provided in the first embodiment, and hence, description of the subfields SF24-SF2M of the second group will be omitted.

In detail, the discharge cells of the row electrodes may be reset to be non-light emitting cells in the reset periods R21-R23 of the subfields SF21-SF23 of the first group, and they may be set to be write dischargeable in the address periods WA21-WA25.

In the address periods WA21-WA23 of the first subfield SF21, the discharge cells to be set as light emitting cells may be write discharged from among discharge cells of the row electrodes to form wall charges. That is, a write discharge may be sequentially performed for the row electrodes in the address periods WA21-WA23 to select light emitting cells, and predetermined operations may be performed in the sustain periods S21-S23 to sustain discharge the light emitting cells.

It is also possible to divide the row electrodes into a plurality of row groups and drive them in the subfields SF21-SF23 of the first group. When the row electrodes are divided into row groups, operations on the sustain period may be respectively performed for the respective row groups. For example, when they are divided into 8 row groups, 8 operations for the sustain period are performed. Accordingly, the length of the total sustain periods in one subfield is increased, limiting the number of subfields usable for one field. When the row electrodes are driven without grouping them as described in the second embodiment of the present invention, the length of the sustain period may be reduced, since one sustain period S21-S23 may be performed in the respective subfields SF21-SF23 of the first group.

Since the subfields SF21-SF23 of the first group respectively have reset periods R21-R23, the current cell may be set to be a light emitting cell irrespective of the cell state of a previous subfield. Therefore, the discharge cells in the subfields SF21-SF23 of the first group may be sustain discharged. In this instance, when the relative lengths of the sustain periods S21-S23 of the subfields SF21-SF23 of the first group, i.e., the weights, may be 1, 2, and 4, the subfields SF21-SF23 of the first group may express 8 grayscales, i.e., from 0 to 7.

In this instance, the weights of the respective subfields SF21-SF23 of the first group may correspond to the length of one sustain period S21-S23 of the corresponding subfield, and the weights of the respective subfields SF24-SF2M of the second group may correspond to the sum of the lengths of the 8 sustain periods S2N₁-S2N₈ (where N is an integer between 6 and M).

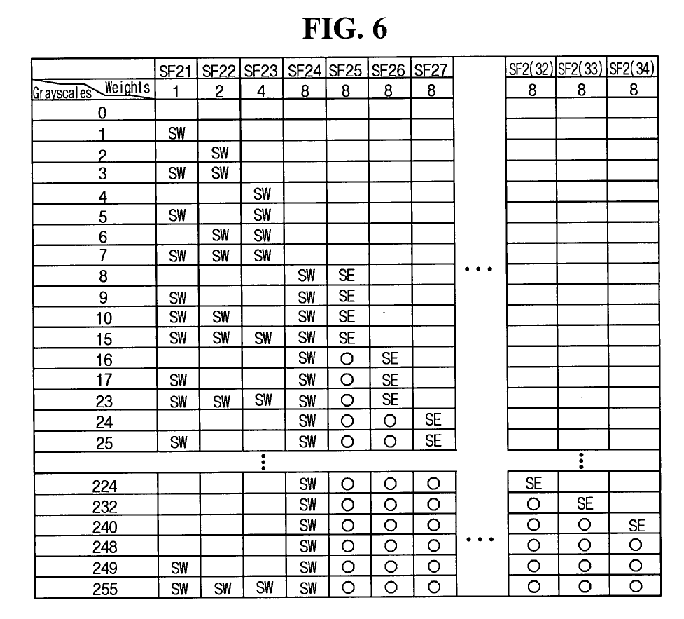

FIG. 6 illustrates a second embodiment of a grayscale expressing method of the present invention using the driving method of FIG. 5.

As shown in FIG. 6, the subfields of the first group may include subfields SF21, SF22, and SF23 having weights of 1, 2, and 4, and the subfields of the first group may express grayscales from 0 to 7. In the subfields SF24-SF2M of the second group, the grayscales may be expressed by subfields that are turned on from the second subfield SF24. When the lengths of sustain periods of the subfields SF24-SF2M of the second group correspond to the length of the sustain period (S21ᵢ) of the minimum weight subfield SF21 of the first group, the weight of the subfields SF24-SF2M of the second group corresponds to 8. The subfields SF24-SF2M of the second group may express grayscales that correspond to multiples of 8 from among the grayscales from the grayscale of 0 to the grayscale of 8×(M−3). For example, the grayscale of 40 (=8×5) may be expressed when an erase discharge is generated in the ninth subfield SF29 after a write discharge is generated in the fourth subfield SF24, and the grayscale of 248 (=8×31) may be expressed when no erase discharge is generated in the subfields SF27-SF2 (31) after a write discharge is generated in the fourth subfield SF26. Grayscales that are not multiples of 8 may be expressed by dithering. Dithering is a technique for combining specific grayscales and averaging them with a predetermined grayscale desired within a predetermined area to thus express the grayscales. For example, the grayscales between 0 and 8 can be expressed by using the grayscale of 0 and the grayscale of 8 in the pixel area.

The grayscale in a field may be expressed by a sum of grayscales expressed by the subfields SF21-SF23 of the first group and the subfields SF24-SF2M of the second group. Therefore, since the grayscales from 0 to 7 may be expressed by the subfields SF21-SF23 of the first group, the grayscales from 0 to 255 (=248+7) may be expressed by combination of the subfields SF21-SF2M of the first group and the second group when there are 31 subfields in the second group. Hence, according to the grayscale expressing method of the second embodiment of the present invention, the number of subfields may be increased so as to increase the number of grayscales expressed by the combination of subfields.

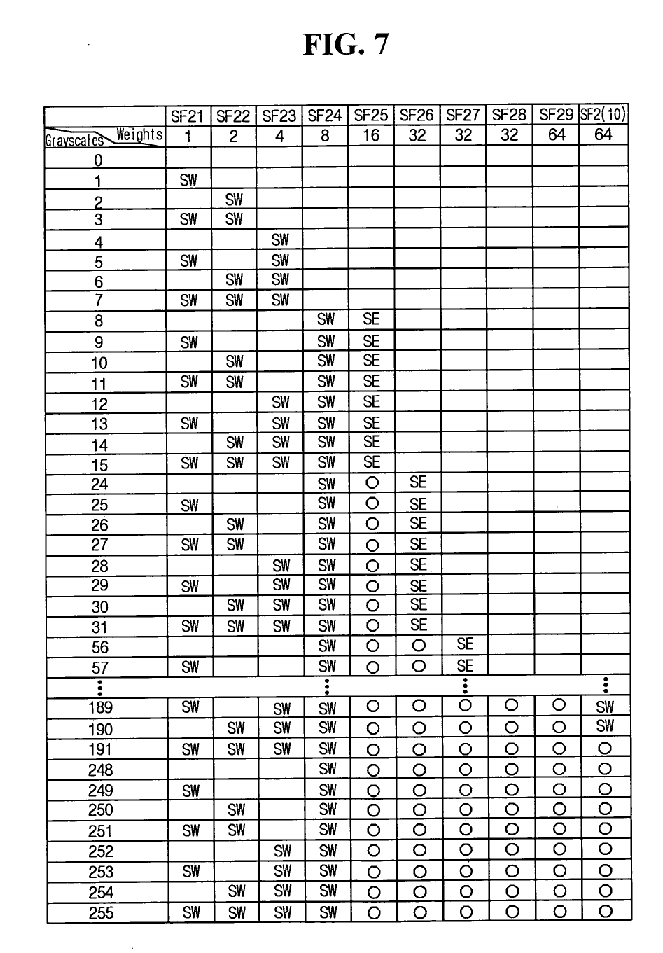

Referring to FIG. 7, a method for increasing the number of grayscales that can be expressed by combination of subfields and reducing the number of subfields will be discussed. FIG. 7 illustrates a grayscale expressing method of the third embodiment of the present invention, using the driving method shown in FIG. 5. FIG. 7 shows that one field has 10 subfields and the subfields SF24-SF2M of the second group have 7 subfields.

As shown in FIG. 7, the grayscale expressing method according to the third embodiment of the present invention is similar to the grayscale expressing method according to the second embodiment of the present invention shown in FIG. 6. However, the weights of the subfields SF24-SF2M of the second group in the third embodiment are different from those of the second embodiment. That is, the subfields SF24-SF2M of the second group may be grouped into a plurality of subfield sub-groups according to the weights of the subfields. In a like manner of the second embodiment, the grayscales from 0 to 7 may be generated by the subfields SF21-SF23 of the first group, and the grayscales may be expressed by the subfields that are consecutively turned on from the fourth subfield SF24 in the subfield SF23-SF2(10) of the second group.

For example, when the subfields SF24-SF2M of the second group are grouped into 4 sub-groups and each sub-group includes subfields having weights of 8, 16, 32, and 64, and, as shown in FIG. 7, the first sub-group includes a subfield having the weight of 8, the second sub-group includes a subfield having the weight of 16, the third sub-group includes 3 subfields having the weight of 32, the fourth sub-group includes two subfields having the weight of 64, the grayscales from 0 to 248 (=8+16+32×3+64×2) may be expressed by the subfields SF24-SF2M of the second group, and the grayscales from 0 to 255 (=248+7) may be expressed by the combination of the subfields SF21-SF2(10) of first group and the second group. That is, 256 grayscales may be realized using fewer subfields than in the second embodiment. The grayscales that cannot be expressed by the combination of subfields of the first and second groups can be expressed by dithering.

In this instance, the respective sub-group of the second group may realize the respective weights by changing the lengths of sustain periods of the subfields SF24-SF2(10). For example, when it is assumed that the length of sustain periods of a row group of the fourth subfield SF4 of the second group is set to be 1, the weight of the fourth subfield SF24 is 8. Therefore, when the length of sustain period of a row group of the corresponding subfield is set to be twice the length of the sustain period of a row group of the fourth subfield SF24, the subfield having the weight of 16 can be realized, and when the length of the sustain period of a row group of the corresponding subfield is set to be four times the length of the sustain period of a row group of the fourth subfield SF24, the subfield having the weight of 32 can be realized.

While the grayscale expressing method used with the driving method of the second embodiment of the present invention were illustrated as having the subfields SF21-SF23 before the subfields SF24-SF2(M), the subfields SF21-SF23 may after the subfields SF24-SF2M.

Also, in the first and second embodiments of the driving method of the present invention, the erase periods ER1₂-ER1₈, ER2₂-ER2₈, and ER3₂-ER3₈ and additional sustain periods SA1₂-SA1₈, SA2₂-SA2₈, and SA3₂-SA3₈) may be formed in the last subfields SF1L, SF2M, and SF3M of a field, and the same can be deleted. When the erase periods ER1₂-ER1₈, ER2₂-ER2₈, and ER3₂-ER3₈ and the additional sustain periods SA1₂-SA1₈, SA2₂-SA2₈, and SA3₂-SA3₈ are deleted, the addressing order for the row groups over a plurality of fields may be changed to control the number of sustain discharges for the row groups to be the same.

As described above, according to the above-described embodiments of the present invention, the address period between the sustain periods of each row group may sufficiently use the priming particles formed in the sustain period, and hence, high-speed scanning is possible by reducing the width of the scan pulse.

As described above, according to the above-described embodiments of the present invention, a plurality of subfields in a field may be divided into a plurality of subfield groups. The first subfield group may include a plurality of subfields having weights, and may select light emitting cells by the selective write address method. The second subfield group may include a plurality of subfields and may select light emitting cells, at least one subfield of the earliest subfields may select light emitting cells by the selective write address method, and other subfields may select non-light emitting cells from the light emitting cells by the selective erase address method. The grayscales of the field having the above-noted subfields may be expressed by a sum of weights of subfields of the first and second subfield groups. In this instance, the expression of grayscales may be improved. The number of subfields may be reduced by varying the weights of subfields using the selective erase address method. In addition, the time for generating the address discharge may determined by allocating the time that corresponds to the number of subfields to the address period.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display device driving method for dividing a field into a plurality of subfields and expressing grayscales in a plasma display device including a plurality of row electrodes, a plurality of column electrodes, and a plurality of discharge cells defined by the row electrodes and the column electrodes, the method comprising:
dividing the row electrodes into a plurality of row groups;
dividing the subfields into a plurality of subfield groups;
selecting non-light emitting cells from among light emitting cells of the respective row groups during first address periods of the row groups in the respective subfields of a first subfield group; and
sustain discharging remaining light cell among the light emitting cells of the row groups during a first sustain period provided between two adjacent first address periods in the respective subfields of the first subfield group, wherein
a weight of at least one first subfield of the first subfield group is different from a weight of at least one second subfield of the first subfield group.

2. The plasma display device driving method as claimed in claim 1, further comprising:
selecting light emitting cells from among discharge cells of respective row groups during a second address period for the row groups in the respective subfields of the second subfield group, the second subfield group being before the first subfield group and including at least one subfield; and
sustain discharging the light emitting cells of the row groups during a second sustain period provided between the adjacent second address periods in the respective subfields of the second subfield group.

3. The plasma display device driving method as claimed in claim 2, further comprising:
selecting light emitting cells from among the discharge cells during a third address period in the respective subfields of the third subfield group, the third subfield group being before the second subfield group and including a plurality of subfields having respective weights; and
sustain discharging the light emitting cells during a third sustain period in the respective subfields of the third subfield group.

4. The plasma display device driving method as claimed in claim 3, further comprising:
resetting the discharge cells to be non-light emitting cells before selecting the light emitting cells in the respective subfields of the second and third subfield groups.

5. The plasma display device driving method as claimed in claim 1, further comprising, after sustain discharging the light emitting cells of a last row group from among the row groups in a last subfield in the first subfield group,
setting the light emitting cells of the row groups to be non-light emitting cells during an erase period of the row groups; and
sustain discharging the discharge cells in the light emitting cell state of the row groups during an additional sustain period provided between two erase periods.

6. A plasma display device driving method for dividing a field into a plurality of subfields and expressing grayscales in a plasma display device including a plurality of row electrodes, a plurality of column electrodes, and a plurality of discharge cells defined by the row electrodes and the column electrodes, the method comprising:
dividing the subfields into a plurality of subfield groups including a first subfield group and a second subfield group;
selecting light emitting cells from among the discharge cells;
sustain discharging the light emitting cells in the first subfield group including a plurality of subfields having weights;
dividing the row electrodes into a plurality of row groups in the second subfield group;
selecting light emitting cells from among the discharge cells of a first row group from among the row groups;
sustain discharging the light emitting cells of the row groups in at least one first subfield that begins the second subfield group;
dividing a plurality of second subfields of the second subfield group into a plurality of subfield sub-groups having weights;
selecting non-light emitting cells from the light emitting cells of the first row group; and
sustain discharging remaining light emitting cells among the light emitting cells of the row groups in the second subfields of the subfield sub-groups.

7. The plasma display device driving method as claimed in claim 6, further comprising:
resetting the discharge cells to be non-light emitting cells before selecting the light emitting cells in the first subfield of the second subfield group and the respective subfields of the first subfield group.

8. The plasma display device driving method as claimed in claim 7, further comprising:
selecting light emitting cells from among the discharge cells of the second row group from among the row groups;
sustain discharging the light emitting cells of the row groups in the first subfield of the second subfield group;
selecting non-light emitting cells from among the discharge cells of the second row group from among the row groups; and
sustain discharging light emitting cells of the row groups in the second subfield of the respective subfield sub-groups.

9. The plasma display device driving method as claimed in claim 8, further comprising, after sustain discharging the light emitting cells of a last row group of the row groups in a last second subfield of the second subfield group:
setting the light emitting cells of the first row group from among the row groups to be non-light emitting cells;
sustain discharging light emitting cells of the row groups;
setting the light emitting cells of the second row group from among the row groups to be non-light emitting cells; and
sustain discharging light emitting cells of the row groups.

10. The plasma display device driving method as claimed in claim 6, wherein differences between weights of adjacent subfields in the second subfield group are equal.

11. The plasma display device driving method as claimed in claim 6, wherein at least one difference between weights of adjacent subfields in the third subfield group is different from another difference between weights of adjacent subfields.

12. The plasma display device driving method as claimed in claim 6, wherein all weights of subfields in the second subfield group are smaller than any weight of subfields in the first subfield group.

13. The plasma display device driving method as claimed in claim 6, wherein sustain discharging of the light emitting cells in the first subfield group occurs before sustain discharging light emitting cells of the row groups in the first subfield of the subfield sub-groups.

14. A plasma display device comprising:
a plasma display panel (PDP) including a plurality of row electrodes having first electrodes and second electrodes and a plurality of column electrodes formed to cross the row electrodes, wherein a plurality of discharge cells are formed by the row electrodes and the column electrodes;
a controller for dividing the row electrodes into a plurality of row groups, dividing the subfields into a plurality of subfield groups, and expressing grayscales, and
a driver for selecting non-light emitting cells from among light emitting cells of the row groups during first address periods of the row groups and sustain discharging remaining light emitting cells among the light emitting of the row groups during a first sustain period provided between two adjacent first address periods in respective subfields of the first subfield group, wherein
the controller controls a length of a first sustain period of at least one first subfield from among subfields of the first subfield group to be different from a length of a first sustain period of at least one second subfield from among subfields of the first subfield group.

15. The plasma display device as claimed in claim 14, wherein
the driver selects light emitting cells from among discharge cells of the row groups during second address periods of the row groups in the respective subfields of the second subfield group including the row groups that are provided before the first subfield group and that are the same number as that of the first subfield group, and
the driver sustain discharges the light emitting cells of the row groups during a second sustain period provided between two adjacent second address periods in the respective subfields of the second subfield group.

16. The plasma display device as claimed in claim 15, wherein
the driver selects light emitting cells from among the discharge cells during a third address period and sustain discharges the light emitting cells during a third sustain period in the respective subfields of the third subfield group that is provided before the second subfield group and has subfields having weights.
